(19) United States
(12) Patent Application Publication
(10) Pub. No.: US 2014/0129041 A1
(43) Pub. Date: May 8, 2014

(54) SYSTEM AND METHOD FOR CONTROLLING AT LEAST ONE DEVICE

(71) Applicants: Sony Europe Limited, Weybridge (GB); Sony Corporation, Minato-ku (JP)

(72) Inventor: David Rowland WILLIAMS, Cardiff (GB)

(73) Assignees: Sony Europe Limited, Weybridge (GB); Sony Corporation, Minato-ku (JP)

(21) Appl. No.: 13/957,668

(22) Filed: Aug. 2, 2013

(30) Foreign Application Priority Data
Nov. 2, 2012 (GB) 1219800.8

(51) Int. Cl. G05B 13/02

(52) U.S. Cl. CPC G05B 13/02
USPC 700/295

(57) ABSTRACT

A system controls electrical devices associated with a property such as a domestic dwelling. The system includes a local area network to provide a facility for communicating with the electrical devices and includes a wireless access gateway. Mobile devices include a transmitter and a receiver for communicating with the wireless access gateway. A controller connected to the network detects a relative location of the mobile devices depending on whether the mobile devices can communicate via the wireless access gateway. A data store stores an indication of an operating state for the electrical devices. A setting for the electrical devices is selected as a function of a relative location of the mobile devices with respect to the property. The controller, in response to a change in the location of the mobile device, changes the operating state of the electrical devices in accordance with the setting and to update the operating state.

### CROSS REFERENCE TO RELATED APPLICATION

The present application claims priority to United Kingdom patent application No GB1219800.8, filed in the UKIPO on 2 Nov. 2012, the entire contents of which being incorporated herein by reference.

### TECHNICAL FIELD OF THE INVENTION

The present disclosure relates to systems and methods for controlling one or more electrical devices associated with a property such as a domestic premise, office building, commercial property or industrial unit or the like.

### BACKGROUND OF THE INVENTION

There are various arguments for promoting a reduction in the consumption of energy in order to reduce the impact of human activity on our environment. In recent years various measures have been introduced such as increasing the insulation in buildings as well as the replacement of conventional filament electric light bulbs with LED and florescent low energy luminaries. Furthermore domestic appliances have become increasingly energy efficient in order to reduce power consumption. Of course a reduction in power consumption by a consumer will also reduce electricity bills.

It is known to provide near field communications devices for various applications such as for example setting or un-setting an intruder alarm using a so called “tag” or “key fob”. The tags can be individually identified, so that a particular user who set or unset the alarm can be recognised and recorded by the alarm system. In other examples domestic pets maybe “chipped” in which an identification chip is inserted under an animal's skin to provide a unique identification which can be used to identify the animal and control access to a property using near field communication technology.

As will be appreciated therefore, it is desirable to provide further efficiencies to reduce power consumption associated with a property such as a domestic dwelling or office block.

### SUMMARY

In embodiments there is provided a system for controlling one or more electrical devices associated with a property such as a domestic dwelling, an office block, a commercial building or an industrial unit or the like. The system comprises a local area network configured to provide a facility for communicating with the one or more electrical devices associated with the property and includes a wireless access gateway. One or more mobile devices include a transmitter and a receiver for communicating with the wireless access gateway of the local area network. A controller connected to the local area network is configured to detect a relative location of the one or more mobile devices depending on whether the one or more mobile devices can communicate via the wireless access gateway and a data store is configured to store an indication of an operating state for the one or more electrical devices associated with the property. The setting for the one or more electrical devices is selected as a function or a relative location of the mobile devices with respect to the property. The controller is configured in response to a change in the location of the mobile device to change the operating state of the one or more of the electrical devices in accordance with the setting indicated in the data store and to update the operating state in the data store.

Embodiments of the present disclosure can provide a system for improving the control of electrical devices within a property to match the presence or absence of one or more users of the electrical devices with respect to the property. Accordingly, by changing the state of the electrical devices in response to the presence or absence of a user as detected by the presence of absence of a mobile device which is used by the user, the electrical devices can arranged to operate in a way which matches more closely the requirements of the users. As a result, in one example, an improvement in energy efficiency can be achieved by for example powering down devices when these are not required because one or more of the users are not present. In one example a television which is typically configured to provide a standby mode in which the device can be powered on for displaying television programmes at short notice is arranged to include an operating state in which it is powered off, in which the television is moved from a standby setting to a power off setting thereby saving energy. In another example, lighting on the property maybe reduced or increased in response to the detected presence or absence of a mobile device associated with a user and an intruder alarm can be set or unset in response to the presence of the user. To this end, embodiments of the present disclosure can include a data store providing a database in which each user associated with a property has an entry which indicates a device which that user may use and may include an indication of one or more electrical devices which the user may use. Accordingly, in response to a change in the presence or absence of a user as detected by whether or not a mobile device associated with the user can send or receive signals via a wireless access interface, various electrical devices within the property can be controlled to match the operating state of the device in accordance with its function. For example an intruder alarm may be set or un-set or devices may be controlled to adopt a low power consumption state when the user is absent to save energy.

Although it is known to control devices using near field communication technology, such as the use of a key fob for setting or un-setting an intruder alarm or a domestic pet access door (cat flat) recognising the pet from an embedded chip, embodiments of the present disclosure utilise a Wi-Fi connections which is inherently available on many mobile devices to detect the presence or absence of a device. Embodiments therefore re-use a capability which is already present in a mobile device, such as a smart phone, providing a simplified and low cost solution to detect the presence or absence of a user, which does not require a sophisticated set-up and deployment.

Various aspects and features of the present disclosure are defined in the appended claims, including but not limited to a system and method for controlling electrical devices.

### BRIEF DESCRIPTION OF DRAWINGS

Embodiments of the present disclosure will now be described by way of example only with reference to the accompanying drawings in which like parts are provided with corresponding reference and in which:

FIG. 1 provides a schematic representation of a property which includes a local area network;

FIG. 2 provides a schematic block diagram illustrating electrical devices which are connected to a wireless area network and includes to a wireless access gateway;

FIG. 3a is an illustrative representation of a mobile device showing an example of the mobile device receiving signals from the wireless access gateway and therefore attached to the wireless access gateway; and FIG. 3b is a representation of the mobile device not receiving signals from the wireless access gateway and therefore not attached; and FIG. 3c is a schematic block diagram illustrating example components of the mobile device;

FIG. 4 is a schematic block diagram illustrating an example embodiment of the present disclosure;

FIG. 5 is a table showing an example arrangement of a database shown in FIG. 4;

FIG. 6 is a further example arrangement of a database which is shown in FIG. 4;

FIG. 7 is a table illustrating an arrangement of the database shown in FIG. 4; and

FIG. 8 is a flow diagram illustrating an example operation of one embodiment of the present disclosure.

### DESCRIPTION OF EXAMPLE EMBODIMENTS

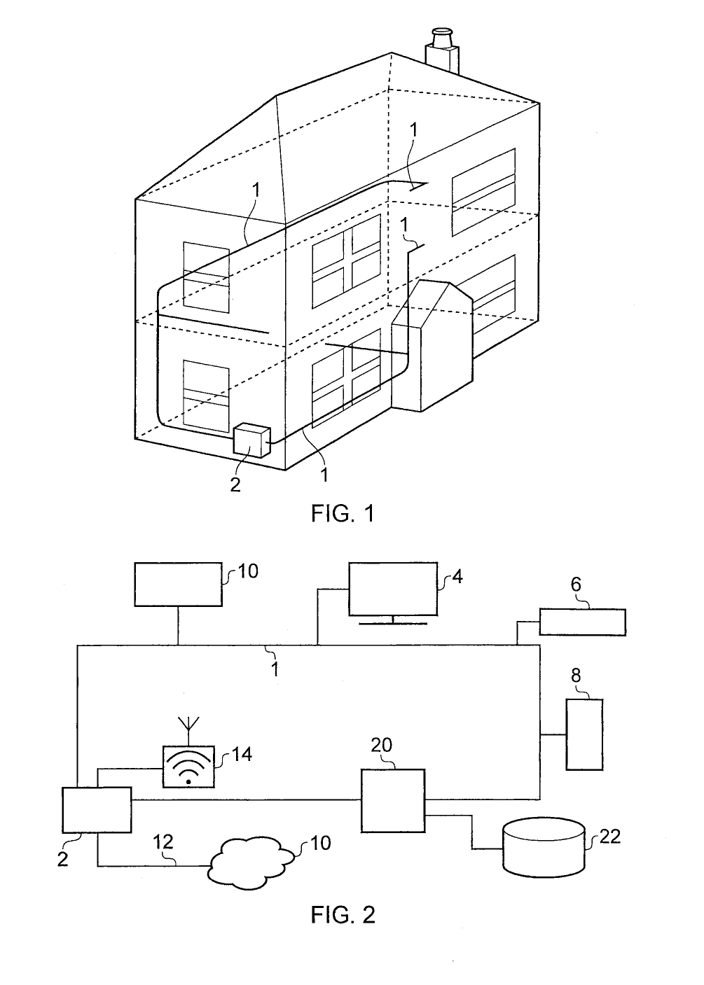

Example embodiments of the present disclosure will now be described with reference to FIGS. 1 and 2 which respectively show an example of a property in which a local area network is deployed. FIG. 1 provides an example of a property which may be a domestic dwelling and in this example a house. Various rooms in the house are shown connected to a local area network provided by cables 1 and a home server or hub 2.

As will be appreciated within each room of the house various electrical devices are deposed and may include a television, a set top box, a washing machine, domestic lighting as well as an intruder alarm and other electrical devices. As shown in FIG. 2, the electrical devices which include a television 4, a set top box 6, an intruder alarm 8, a domestic light controlling circuit 10 are connected to the local area network formed by the cable 1 and the home hub 2. The home hub 2 is connected to the internet 11 via cable 12 and also includes a wireless access gateway 14.

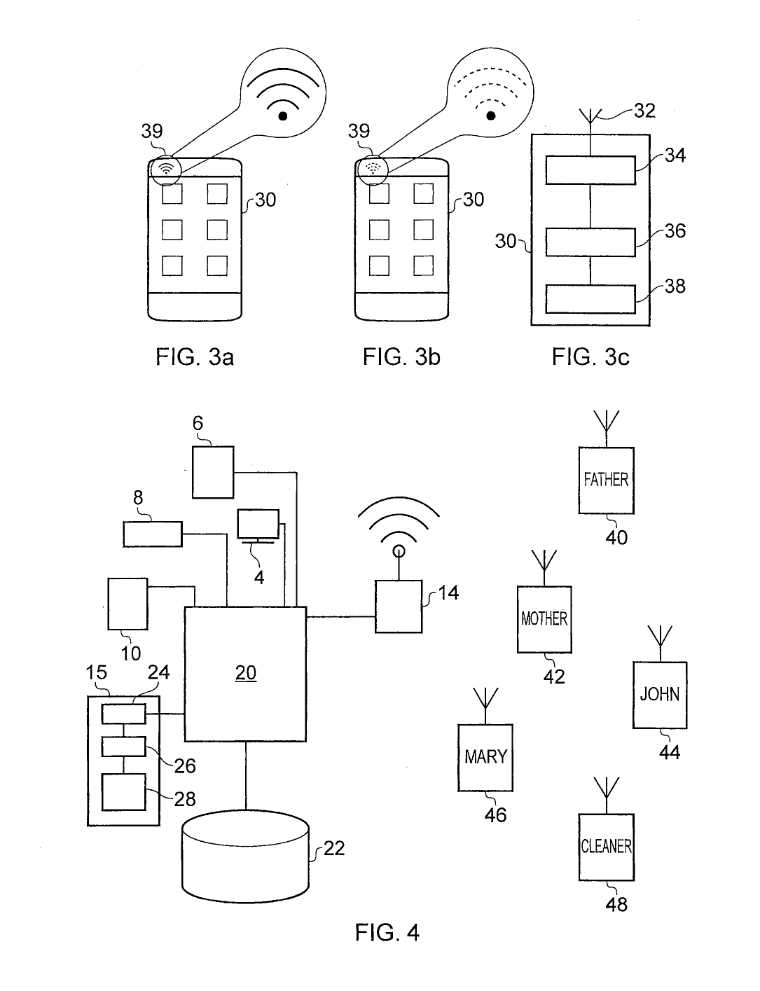

In accordance with the present technique the various electrical devices 4, 6, 8, 10 shown in FIGS. 1 and 2 are controlled by a controller 20 which uses a data store which hosts a database 22 of information with respect to which the electrical devices 4, 6, 8, 10 are controlled. The electrical devices 4, 6, 8, 10 are controlled with respect to the presence or absence of one or more users of the property which in the case of a domestic dwelling provides the users with a home. According to the present technique the presence or absence of a user is detected using mobile devices which are inherently associated with the user, for example, a mobile telephone. In one example, the mobile telephone is used to detect the presence or absence of a user in accordance with whether or not the mobile telephone can form an internet connection via the wireless access gateway 14. As shown in FIG. 3c a mobile telephone 30 typically includes a transceiver device 34 which can transmit and receive data via a wireless access gateway for example IEEE802.11b known as Wi-Fi depending on whether or not the mobile device is within range of the wireless access gateway 14. A controller 34 of the mobile device 30 is arranged to detect radio signals and to control the transceiver unit 34 to attach and detach from the wireless access gateway. The mobile device 30 typically includes an application layer processor 38 for executing application programs for providing services to the user. Thus as shown in FIG. 3a if the mobile device is within range of the wireless access gateway 14 then an indication 39 is provided by the controller 36 that the signals transmitted and received from the wireless access gateway 14 are sufficient to communicate data and more particularly to communicate data packets via the wireless access gateway 14 and therefore attach to the wireless access gateway. If however the mobile device 30 is out of range, the mobile device is not able to communicate via the wireless access gateway, which is illustrated in FIG. 3b. Furthermore the mobile device is not connected to the wireless access gateway and therefore detached in that it is unable to acquire an internet protocol address. Thus using an internet protocol address the mobile device may be identified and therefore associated with a user of that device. Furthermore by recording a previous internet protocol (IP) address acquired by the mobile device and the mobile device also communicating the previously acquired address, the controller is able to recognise the mobile device and therefore associate the mobile device with a user.

A more simplified functional block diagram illustrating the present technique is shown in FIG. 4 which corresponds to the example shown in FIGS. 2 and 3 but presented in a more simplified form in order to explain example embodiments of the present technique.

In FIG. 4, the controller 20 is shown connected to each of the electrical devices 4, 6, 8, 10 and to the wireless access gateway 14 as shown in FIG. 4 the controller 20 is also connected to the data store 22 which hosts a database for identifying each of a plurality of users associated with the property and includes an operating state for each of the electrical devices which are to be controlled within the property. Also shown in FIG. 4 is a plurality of mobile devices 40, 42, 44, 46, 48 which are respectively used by different users which for the present example are labelled “Father”, “Mother”, “John”, “Mary” and “Cleaner” respectively.

Embodiments of the present disclosure provide an arrangement in which users of a property connect to a home network and information generated in accordance with the presence or absence of the users (using the mobile devices 40, 42, 44, 46, 48) is used to control the electrical devices 4, 6, 8, 10. The data store 22 stores a database of devices with respect to which entries are made in a table identifying a configuration of these devices that is for example whether or not they have Wi-Fi access via the wireless access gateway 14. The database can be configured to add automatic prompts as new devices are enabled for configuration and entered into the database in accordance with a user's preferences. Thus as the mobile devices enter or leave a proximity of the network as detected by whether or not they can communicate via the wireless access gateway 14 then a state within the database provided by the data store 22 is changed and updated under the control of the controller 20. In accordance with the presence or absence of the users then various of the electrical devices 4, 6, 8, 10, 15 can be configured and controlled to change their state and depending upon the respective presence or absence. Furthermore, the control and setting state of the electrical devices can be varied in accordance with whether a particular user is present or absent.

In FIG. 4, a more detailed illustration of a networked electrical device 15 connected to the local area network 1 is shown. The network device comprises a transceiver unit 24 connected to the network controller 20 via the local area network 1 and is configured to send data to and receive data from the network controller 20 via the local area network 1. The electrical device 15 includes a controller 26 configured to determine a first state of the networked electrical device 15, to communicate the first state of the network device to the network controller 20 and to receive a message from the network controller 20 to change the state of the networked electrical device 15 to a second state via the local area network 1 as a result of a change in a relative location of a mobile device associated with a user as a result of the mobile device attaching to or detaching from a wireless access gateway attached to the local area network. The networked electrical device 15 responds to the message by changing the operating state of the networked electrical device 15 from the first state to the second state, and communicating to the network controller 20 that the networked electrical device 15 has changed operating state to the second state. The first state may for example correspond from a powered-up mode and the second state may correspond to a powered-down mode of an electrical circuit 28.

In one embodiment a mobile device 30 associated with a user communicates using the transceiver unit 34 via the wireless access gateway 14 to the local area network 1, attaching to the wireless access gateway, when in a radio range of the wireless access gateway 14. Correspondingly, the mobile device 30 detaches from the wireless access gateway 14 when not in range. The device controller 36 may receive an indication that in response to the mobile device attaching or detaching from the wireless access gateway 14 a change in a relative location of the mobile device has caused the network controller 20 to change the state of one or more of the electrical devices in accordance with the state indicated in the data store 22 and to update the operating state in the data store 22. The operating state of one or more of the electrical devices may be selected as a function of a relative location of the mobile device 30 with respect to the property.

As will be appreciated using a Wi-Fi device to detect the presence or absence of mobile devices is just one example of a proximity detection tool and in other embodiments a Bluetooth connectivity or RFID could be used to detect the presence of absence of a mobile device, or indeed combined with detecting a Wi-Fi connection to determine the location of a mobile device and therefore a user within a room. For example a Global Positioning System (GPS) device forming part of the mobile device could be used to determine the location of a user and in particular the location of a user within a room. Other technologies such as technologies being developed by the “In-Location Alliance” could be used to determine the location of the mobile device within the house. In-Location Alliance is an industry body developing accurate mobile indoor positioning with technologies for achieving this aim being based on enhanced Bluetooth® 4.0 low-energy technology and Wi-Fi standards. These technologies are commonly used in mobile handsets and are thus a natural starting point for indoor location identification. For in room and level (height) detection there could be provided a multi room detection system if there are hub devices in each room or in regions of a dwelling. In some examples direct signal strength to each hub could be used as a means for determining which room a user is nearest, or alternatively could use a calculation by comparing the signal strength from each hub to be a type of triangulation to determine a more accurate location. Alternatively or additionally a dwelling could be mapped by a user, for example providing a type of registration by going to each room and selecting each position so that each hub is provided with a signal strength “fingerprint” for future use.

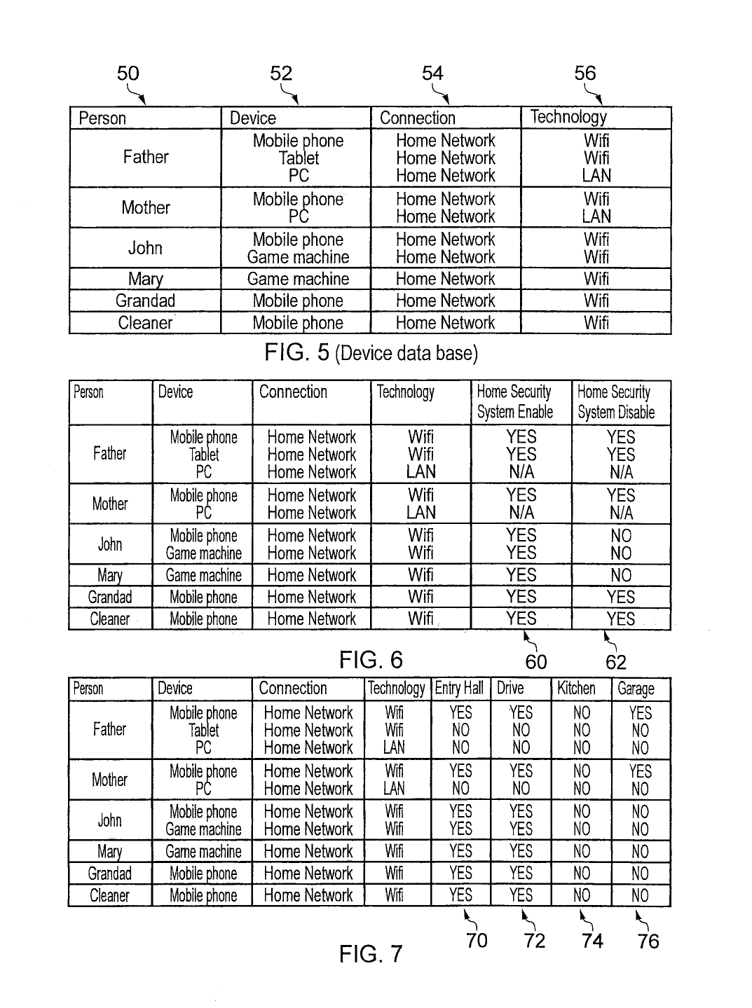

FIG. 5 provides an example configuration of a database in which each of the users in provided within a first column 50 and each of one or more devices associated with the user is shown in column 52. In a third column, an indication is provided as to whether or not the device is connected to a home network and in a fourth column 56 there is an indication of the type of connectivity for the device.

In accordance with the present technique based on proximity information from the database, security systems for example can be enabled and disabled automatically. For example, when a user returns home, falling within range of the wireless access gateway 14 the database provided by the data store 22 can be updated and the security system can be disabled. Alternatively, if the user leaves the proximity of the wireless gateway 14 then the alarm can be enabled. A possible arrangement of the database for providing an enabling or disabling capability is shown in FIG. 6 which corresponds substantially to the table shown in FIG. 5 except that for each user a fifth and sixth column 60, 62. The fifth and sixth columns 60, 62 include an entry as to whether or not the particular user is entitled to enable the system in accordance with their presence or disable the system with the presence. For example John is entitled to enable the system but is not entitled to disable the intruder alarm system. In contrast Cleaner is able to enable the intruder alarm system and able to disable the intruder alarm system. Accordingly, the control of the intruder alarm system can be enabled or disabled depending on both the proximity of the user and differentiated between users.

As will be appreciated in some examples, embodiments may be arranged to cater for a lost or stolen mobile device to the effect that an additional confirmation may be incorporated into the security system for example before the security system is enabled a confirmation code may be requested from the mobile device or if the alarm is disabled by the proximity method a code could be requested by the security device on entry but a time for inputting the code could be increased in order to indicate that the mobile device is a trusted mobile device and owned by the user. In other examples a temporary loss of proximity data, for example, as a result of a power failure could result in a conventional security arrangement being reintroduced for enabling or disabling the intruder alarm. In addition, a loss of wifi due to an ISP or hub malfunction could also automatically switch to an arrangement for traditionally setting or unsettling an intruder alarm. In further examples doors could be deadlocked in response to the intruder alarm being set and other time related logic could be applied with respect to times when the system cannot be enabled or disabled, for example, overnight, at weekends or early in the morning.

A further example of embodiments of the present disclosure is illustrated with respect to a table shown in FIG. 7 which is adapted to provide information and logic within the database provided by the data store 22 which can control an operating state of electrical devices in order to conserve energy for example, domestic lighting within the house. As shown in the table of FIG. 7 which includes further four columns with respect to the example shown in FIG. 5 for each room for example in the house in this example providing examples for “entry hall”, “drive”, “kitchen” and “ garage” each user is provided with a respective entry to indicate whether or not the lighting within each of the rooms should be enabled consequent on the presence of the user being detected. Thus based on proximity information of the user as provided by the detection of the presence or absence of the user from communicating using the wireless access gateway, specific item systems could be enabled or disabled in dependence upon the entries in the database. In one example the lighting is enabled when the first user within the database is detected and dust sensors could be used to control the activation depending upon the location of the lighting.

In other examples, individual and electrical devices are entered into the table and the state controlled independence upon the presence or absence of the user. For example, a domestic television could be configured to include three modes which could be controlled by the controller 20. In the first mode the television could be on, and a second mode the television could be on standby, and the third mode the television is powered off completely. Thus when one of the users becomes present at the property the television could be moved to a standby mode from the power off mode whereas if the detection of all users is absence of the property then the television could be moved to a power off mode. Accordingly, an energy saving can be achieved in a way which does not inconvenience users in waiting too long to operate the television.

In further examples heating could be controlled in a commercial environment to the effect that once an employee arrives at his place of work and the employee's presence is detected, then some electrical devices in the employee's working area could be activated via a network. For example if the employee's working area is an office then related lights, heating, security sensors, coffee machine, water heaters or a tea urn boiler etc could be configured automatically. Thus the database could be configured with entries to turn-on, on arrival and turn-off on departure, using the appropriate logic that is assigned to the database for each employee. In another example, security sensors could be activated and the occurrence of connecting to or leaving the network can result in a data base input which can also be logged for future analysis checking, so that a log is created of who, when (time at work/duration) and where could be recorded in the data base.

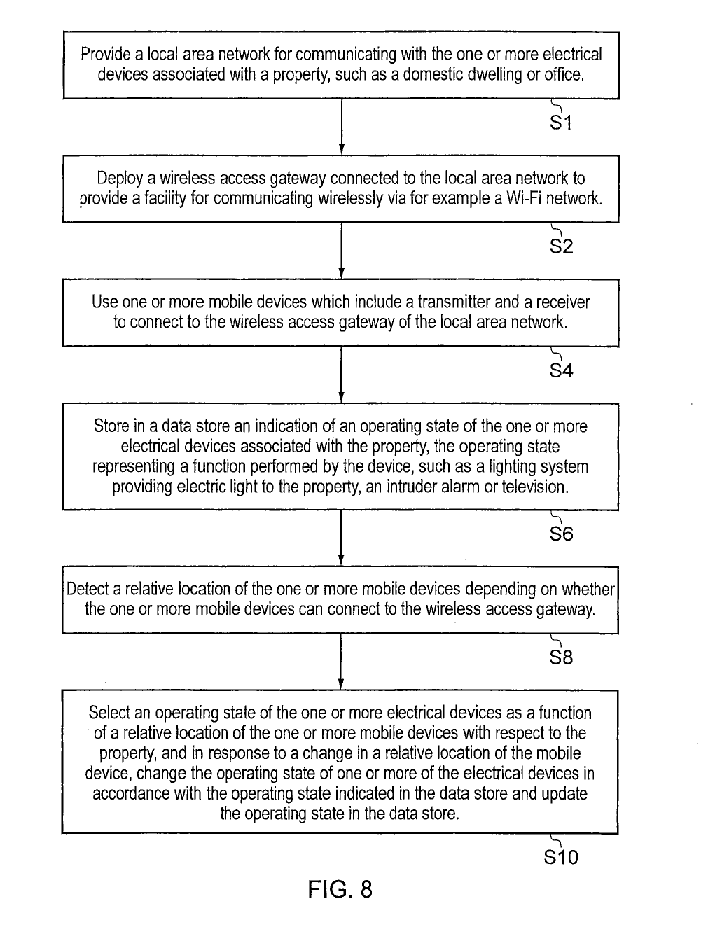

A summary operation of the system in accordance with an example embodiment is shown in FIG. 8, which is explained as follows:

S1: Use a local area network to provide a facility for communicating with electrical devices associated with the property, which are connected to the local area network.

S2: Provide a wireless access gateway connected to the local area network to provide a facility for communicating wirelessly. Thus the electrical devices to be controlled may be connected to the local area network using the wireless access gateway.

S4: Use one or more mobile devices which include a transmitter and a receiver to connect to the wireless access gateway of the local area network. For example the wireless access gateway may provide a WiFi connection to the local area network, so that when a mobile device is within range of the wireless access gateway the mobile device can acquire an internet protocol address.

S6: Using a data store, create a data base of entries in which, for each of the electrical devices, an indication is provided of an operating state of the one or more electrical devices associated with the property. The operating state therefore reflects a function of the device concerned such as whether an intruder alarm is set of un-set or a temperature setting of a central heating system.

S8: Detect a relative location of the one or more mobile devices depending on whether the one or more mobile devices can connect to the wireless access gateway.

S10: Select the operating state of the one or more electrical devices as a function of a relative location of the one or more mobile devices with respect to the property, and in response to a change in a relative location of the mobile device, change the operating state of one or more of the electrical devices in accordance with the operating state indicated in the data store and update the operating state in the data store.

Various further aspects and features of the present disclosure are defined in the appended claims. Various modifications may be made to the embodiments herein and before described without departing from the scope of the present disclosure as defined in the appended claims. For example, whilst the example of Wi-Fi has been given in the embodiments described above it will be appreciated that any other wireless access interface which identifies a mobile terminal could be used.

It will be appreciated that the description of the embodiments could be made with reference to different functional units and/or processors. However, it will be apparent that any suitable distribution of functionality between different functional units or processors may be used without detracting from the embodiments. The embodiments described above may be implemented in any suitable form including hardware, software, firmware or any combination of these. The described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, embodiments may be implemented in a single unit or may be physically and functionally distributed between different units and processors.

Although the present disclosure has been described in connection with some embodiments, it is not intended to be limited to the specific form set forth herein. Additionally, although a feature may appear to be described in connection with particular embodiments, one skilled in the art would recognize that various features of the described embodiments may be combined in any manner suitable to implement the disclosed technique.

Various further aspects and features are defined in the attached numbered clauses:

1. A system for controlling one or more electrical devices associated with a property, the system comprising

a local area network configured to provide a facility for communicating with the one or more electrical devices associated with the property and including a wireless access gateway,

one or more mobile devices including a transmitter and a receiver for communicating with the wireless access gateway of the local area network,

a controller connected to the local area network and configured to detect a relative location of the one or more mobile devices depending on whether the one or more mobile devices can connect to the wireless access gateway, and

a data store configured to store an indication of an operating state of the one or more electrical devices associated with the property, the operating state of one or more of the electrical devices being selected as a function of a relative location of the one or more mobile devices with respect to the property, wherein the controller is configured, in response to a change in the location of the mobile device to change the operating state of one or more of the electrical devices in accordance with the state indicated in the data store and to update the operating state in the data store.

2. A system according to clause 1, wherein the data store includes an indication of a setting for the one or more electrical devices with respect to a relative location of the one or more mobile devices.

3. A system according to clause 1 or 2, wherein the setting of the electrical device with respect to a location of the one or more mobile devices is arranged to reduce a power consumption of the one or more electrical devices.

4. A system according to clause 3, wherein the data base includes an association between a user of each of the one or more mobile devices and the one or more electrical devices, and consequent upon a change of location of one of the mobile devices to change selectively an operating state of the electrical devices which is associated with the user of the mobile device, when the user of the mobile device is associated with the electrical device.

5. A system according to any preceding clause, wherein the one or more electrical devices include a television, the television having a standby mode and a power-off mode, and the controller is configured to set the television to the power-off mode when the controller has detected that the one or more mobile devices has left the property.

6. A system according to any preceding clause, wherein the one or more electrical devices includes an intruder alarm system and when the intruder alarm is set to detect an un-authorised presence of an intruder, the controller is configured to unset the intruder alarm when a location of one of the one or more mobile devices is determined as being present on the property.

7. A method of controlling one or more electrical devices associated with a property, the method comprising

using a local area network to provide a facility for communicating with the one or more electrical devices associated with the property, and including a wireless access gateway connected to the local area network to provide a facility for communicating wirelessly,

using one or more mobile devices which include a transmitter and a receiver to connect to the wireless access gateway of the local area network,

detecting a relative location of the one or more mobile devices depending on whether the one or more mobile devices can connect to the wireless access gateway, and

storing in a data store an indication of an operating state of the one or more electrical devices associated with the property, the operating state of the one or more electrical devices being selected as a function of a relative location of the one or more mobile devices with respect to the property, and

in response to a change in a relative location of the mobile device, changing the operating state of one or more of the electrical devices in accordance with the operating state indicated in the data store and updating the operating state in the data store.

8. A method according to clause 7, wherein the data store includes an indication of a setting for the one or more electrical devices with respect to a relative location of the one or more mobile devices.

9. A method according to clause 7 or 8, comprising reducing a power consumption of the one or more electrical devices, by setting the electrical device with respect to a location of the one or more mobile devices.

10. A method according to clause 9, wherein the data base includes an association between a user of each of the one or more mobile devices and the one or more electrical devices, and the method includes changing selectively an operating state of the one or more electrical devices associated with the user of the mobile device, upon a change of location of the mobile device.

11. A method according to any of clauses 7 to 10, wherein the one or more electrical devices include a television, the television having a standby mode and a power-off mode, and the method comprises setting the television to the power-off mode when the controller has detected that the one or more mobile devices has left the property.

12. A method according to any of clauses 7 to 11, wherein the one or more electrical devices includes an intruder alarm system and the method comprises

determining when the intruder alarm is set to detect an un-authorised presence of an intruder, and

unsetting the intruder alarm when a location of one of the one or more mobile devices is determined as being present on the property.

1. A system for controlling one or more electrical devices associated with a property, the system comprising
a local area network circuitry configured to provide a facility for communicating with the one or more electrical devices associated with the property and including one or more wireless access gateways,
one or more mobile devices including a transmitter and a receiver for communicating with the one or more wireless access gateways of the local area network,
a controller circuitry connected to the local area network and configured to detect a relative location within the property of the one or more mobile devices depending on the connection signal strength to the one or more wireless access gateways, and
a data store circuitry configured to store an indication of an operating state of the one or more electrical devices associated with the property, the operating state of one or more of the electrical devices being selected as a function of a relative location of the one or more mobile devices with respect to the property, wherein the controller circuitry is configured, in response to a change in the location of the mobile device to change the operating state of one or more of the electrical devices in accordance with the state indicated in the data store and to update the operating state in the data store.

2. A system as claimed in claim 1, wherein the data store includes an indication of a setting for the one or more electrical devices with respect to a relative location of the one or more mobile devices.

3. A system as claimed in claim 1, wherein the setting of the electrical device with respect to a location of the one or more mobile devices is arranged to reduce a power consumption of the one or more electrical devices.

4. A system as claimed in claim 3, wherein the data base includes an association between a user of each of the one or more mobile devices and the one or more electrical devices, and consequent upon a change of location of one of the mobile devices to change selectively an operating state of the electrical devices which is associated with the user of the mobile device, when the user of the mobile device is associated with the electrical device.

5. A system as claimed in claim 1, wherein the one or more electrical devices include a television, the television having a standby mode and a power-off mode, and the controller circuitry is configured to set the television to the power-off mode when the controller has detected that the one or more mobile devices has left the property.

6. A system as claimed in claim 1, wherein the one or more electrical devices includes an intruder alarm system and when the intruder alarm is set to detect an un-authorised presence of an intruder, the controller circuitry is configured to unset the intruder alarm when a location of one of the one or more mobile devices is determined as being present on the property.

7. A method of controlling one or more electrical devices associated with a property, the method comprising
using a local area network to provide a facility for communicating with the one or more electrical devices associated with the property, and including a wireless access gateway connected to the local area network to provide a facility for communicating wirelessly,
using one or more mobile devices which include a transmitter and a receiver to connect to the wireless access gateway of the local area network,
detecting a relative location of the one or more mobile devices depending on whether the one or more mobile devices can connect to the wireless access gateway, and
storing in a data store an indication of an operating state of the one or more electrical devices associated with the property, the operating state of the one or more electrical devices being selected as a function of a relative location of the one or more mobile devices with respect to the property, and
in response to a change in a relative location of the mobile device, changing the operating state of one or more of the electrical devices in accordance with the operating state indicated in the data store and updating the operating state in the data store.

8. A method as claimed in claim 7, wherein the data store includes an indication of a setting for the one or more electrical devices with respect to a relative location of the one or more mobile devices.

9. A method as claimed in claim 7, comprising reducing a power consumption of the one or more electrical devices, by setting the electrical device with respect to a location of the one or more mobile devices.

10. A method as claimed in claim 9, wherein the data base includes an association between a user of each of the one or more mobile devices and the one or more electrical devices, and the method includes changing selectively an operating state of the one or more electrical devices associated with the user of the mobile device, upon a change of location of the mobile device.

11. A method as claimed in claim 7, wherein the one or more electrical devices include a television, the television having a standby mode and a power-off mode, and the method comprises setting the television to the power-off mode when the controller has detected that the one or more mobile devices has left the property.

12. A method as claimed in claim 7, wherein the one or more electrical devices includes an intruder alarm system and the method comprises
determining when the intruder alarm is set to detect an un-authorised presence of an intruder, and
unsetting the intruder alarm when a location of one of the one or more mobile devices is determined as being present on the property.

13. A network device for connection to a local area network, the network device comprising
a transceiver unit circuitry connected to the local area network and configured to send data to and receive data from a network controller via the local area network,
a controller circuitry configured
to determine a first state of the network device,
to communicate the first state of the network device to the network controller,
to receive a message from the network controller to change the state of the network device to a second state via the local area network as a result of a change in a relative location of a mobile device associated with a user as a result of the mobile device attaching to or detaching from a wireless access gateway attached to the local area network,
to change the operating state of the network device from the first state to the second state, and
to communicate to the network controller that the network device has changed operating state to the second state.

14. A mobile device associated with a user, the mobile device including
a wireless transmitter and a wireless receiver circuitry configured to communicate via a wireless access gateway to a local area network associated with a property, wherein the wireless transmitter and receiver is configured to attach to the wireless access gateway, when in a radio range of the wireless access gateway and to detach from the wireless access gateway when not in range, and
to receive an indication that in response to the mobile device attaching or detaching from the wireless access gateway a change in a relative location of the mobile device has caused a controller attached to the local area network to change the state of one or more electrical devices in accordance with the state indicated in a data store and to update the operating state in the data store, the operating state of one or more of the electrical devices being selected as a function of a relative location of the mobile device with respect to the property.

15. A system according to claim 1, wherein the connection signal strength to two or more wireless access gateways is used to determine the location within the property of the one or more mobile devices.
